(19) United States
(12) Patent Application Publication
(10) Pub. No.: US 2009/0103570 A1
(43) Pub. Date: Apr. 23, 2009

(54) Time Synchronization in Serial Communications

(75) Inventor: Heikki Björkman, Vaasa (FI)

Correspondence Address: BUCHANAN, INGERSOLL & ROONEY PC, POST OFFICE BOX 1404, ALEXANDRIA, VA, 22313-1404, US

(73) Assignee: ABB Oy, Helsinki (FI)

(21) Appl. No.: 11/988,101

(22) PCT Filed: Jun. 29, 2006
(86) PCT No.: PCT/FI2006/050295

§ 371 Date: Mar. 12, 2008

(30) Foreign Application Priority Data
Jun. 29, 2005 (FI) 20055364

(51) Int. Cl. H04J 3/06

(52) U.S. Cl. 370/503

(57) ABSTRACT

A real-time clock (151) for electronic equipment is synchronized by supplying a time signal (4-1) to a serial communications circuit (11) with the data transmission rate adapted so that one character of the time signal can be read into the serial communications circuit as one character. The serial communications circuit (11) initiates (4-2) an interrupt handler (131) that in turn initiates (4-7) a sync task (132). The time signal (4-1) is inverted if necessary before being supplied to the serial communications circuit (11).

### FIELD OF TECHNOLOGY

The invention relates to time synchronization of a device containing a central processing unit and a serial communications circuit, particularly to time synchronization of microcontrollers.

### BACKGROUND OF THE INVENTION

The decreased price and size and increased processing capacity of central processing units have resulted in an increasing number of devices being equipped with data communications features and an ability to forward collected information to various applications. For example, low-level devices such as protective relays or other intelligent electronic devices (IEDs) can forward collected protection, measurement, control or other data to higher-level devices such as remote control systems. An essential factor associated with such data is the time when the data was collected. Devices can also be programmed to execute a certain task or a number of tasks at a specified time or at specified times. Time synchronization has therefore become more important, as the times provided by the real-time clocks contained in the devices are not mutually comparable with the precision required by the applications, such as one-millisecond precision.

For the purpose of time synchronization, the devices are typically supplied with a signal that contains a time for synchronization. In electronic devices using microcontrollers (small computers), the signal used for time synchronization is usually received either by a state machine programmed on an FPGA (Field Programmable Gate Array) circuit or by polling a single I/O (Input/Output) pin on the microcontroller. Adding an FPGA to a device for the sole purpose of time synchronization will increase manufacturing costs. On the other hand, polling, which refers to regularly reading an I/O pin, increases the load on the microcontroller's processing unit, reducing performance.

### BRIEF DESCRIPTION OF THE INVENTION

The objective of the invention is to develop a method and an apparatus to implement the method in order to achieve sufficient precision of time synchronization without loading the processor by polling. The objective of the invention will be accomplished by a method, serial communications circuit, connection arrangement and device characterized by the independent claims. The dependent claims describe preferred embodiments of the invention.

The invention is based on using a serial communications circuit intended for inter-device communication, such as a UART (Universal Asynchronous Receiver & Transmitter) for the purpose of receiving a time signal.

The advantage of the invention is that compared to polling, the processor load will drop to one-tenth or even lower, and in most cases an existing circuit within the device can be used for time synchronization. This eliminates the need to add a separate circuit for time synchronization and may enable the utilization of an unused serial communications circuit contained in the device.

### BRIEF DESCRIPTION OF THE FIGURES

In the following the invention will be described in more detail in connection with preferred embodiments by referring to the enclosed drawings, where

FIG. 1 illustrates a simplified block diagram of the system;

FIG. 2 illustrates a flow diagram of operation according to the invention;

FIGS. 3A and 3B illustrate schematic diagrams of preferred embodiments;

FIG. 4 is a high-level software, data communications and command diagram;

FIG. 5 illustrates the characters that start an inverted time frame;

FIGS. 6, 7 and 8 illustrate the operation of an embodiment of the invention in more detail by means of flow diagrams; and

FIG. 9 is a high-level software, data communications and command diagram for another embodiment.

### DETAILED DESCRIPTION OF SOME EMBODIMENTS

The present invention is applicable to any device that is subject to time synchronization and contains, or can be fitted with, a serial communications circuit in addition to the central processing unit. The serial communications circuit can be a separate circuit, or it can be integrated within a component such as a microcontroller.

In the following the invention will be described using an example system and device that do not limit the scope of the invention. Devices, programming techniques, central processing units, serial communications circuits and means of transmitting time for time synchronization are constantly developing. Such development may require additional changes to the invention. Therefore all words and expressions should be interpreted broadly and are intended to describe the invention, not to limit its scope.

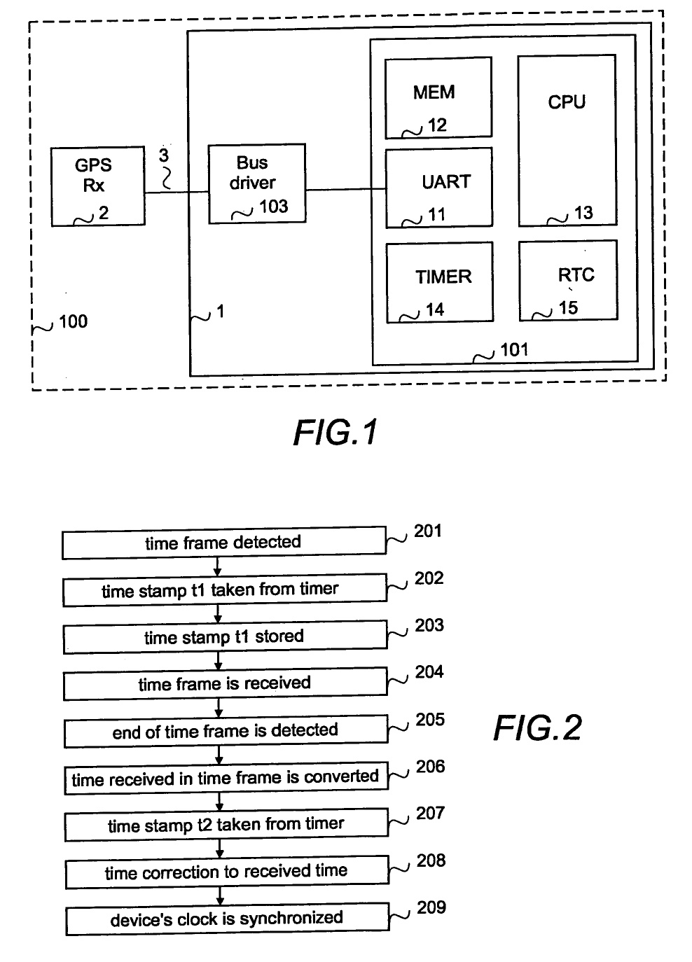

FIG. 1 illustrates a simplified block diagram of a system 100 that comprises a device 1 subject to time synchronization, a device 2 for receiving the time required for time synchronization and a bus 3 connecting these. The detailed structure of the system is not essential for the actual invention and therefore does not need to be described in more detail here; it is obvious to a person skilled in the art that the system may also comprise other devices, functions and structures.

In the example of FIG. 1, the device 1 subject to time synchronization is an IED comprising an integrated circuit with a microcontroller 101 and a bus driver 103. The microcontroller 101 comprises at least a serial communications circuit 11 (UART), memory 12 (MEM), a central processing unit 13 (CPU), a timer 14 (TIMER) and a real-time clock 15 (RTC) subject to time synchronization. The real-time clock can be implemented as a rolling counter in memory. In a device according to the invention, the time signal used for time synchronization is received using the serial communications circuit 11 in a manner described in more detail below. The hardware requirement for the serial communications circuit 11 is that it must be possible to program or otherwise set the data transmission rate (at least the transmission rate for received data) to a rate adapted to the received time signal with sufficient precision, as will be described in more detail below. In this example, it is assumed that the serial communications circuit comprises bus logic and an I/O (input/output) system through which the device communicates with device 2, for example, through bus driver 103. All of the required data is stored in the memory of device 1. The memory 12 may comprise program memory, working memory and/or read-only memory. The memory or any part of it can be external memory or integrated into the microcontroller. The detailed structure of the device is not essential for the actual invention and therefore does not need to be described in more detail here. It is obvious to a person skilled in the art that the device may also comprise other functions and structures. The device can be any device containing a serial communications circuit and a central processing unit. Examples of devices to which the invention is applicable include devices containing a microcontroller, such as protective relays and similar IEDs, PDAs (personal digital assistants), palmtop computers, conventional computers, etc.

In the example of FIG. 1, the device 2 receiving the time required for time synchronization (GPS Rx, Global Positioning System receiver) receives a GPS signal containing the time from a GPS satellite, demodulates the signal into a time signal containing the time and transmits the demodulated time signal to device 1 to which it is connected through bus 3. Preferably the receiving device 2 adds leap seconds to the time contained in the GPS signal in connection with demodulation. Such a modified time would correspond to Coordinated Universal Time (UTC), as GPS time differs from UTC time in that leap seconds are added to UTC time.

Bus 3 can be an RS232 or RS485 cable or an optical fibre, for example, and, deviating from prior art, it is connected to serial communications circuit 11 through a bus driver or an optical fibre receiver. Bus 3 can also be a wireless bus, such as one utilising infrared or Bluetooth.

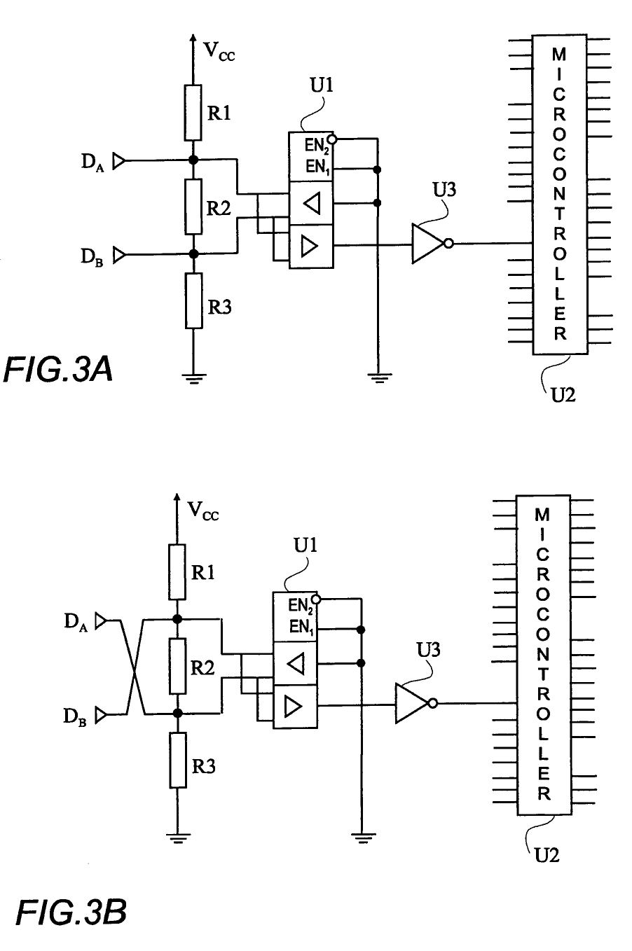

FIG. 2 illustrates the principle of operation according to the invention within the device subject to time synchronization. In FIG. 2, it is assumed that the settings of the serial communications circuit are preferably updated so that the frame length corresponds to the length of one character in the time signal and that the sample rate, if it can be configured, is set to a rate sufficient to provide the required precision of the synchronized time. When the device subject to time synchronization detects the start of a time frame at step 201, it takes a time stamp t1 from the timer at step 202 and stores time stamp t1 at step 203. After this, the time frame is received at step 204. When the end of the time frame is detected at step 205, the time received in the time frame is converted at step 206, a time stamp t2 is taken from the timer at step 207, and time correction to the received time is carried out using time stamps t1 and t2 at step 208. After this, the device's clock is synchronized at step 209 using the time-corrected time received.

Preferably every received start of a time frame will trigger the function described above. A time frame preferably refers to a portion of the time signal that includes the time data and a frame reference marker.

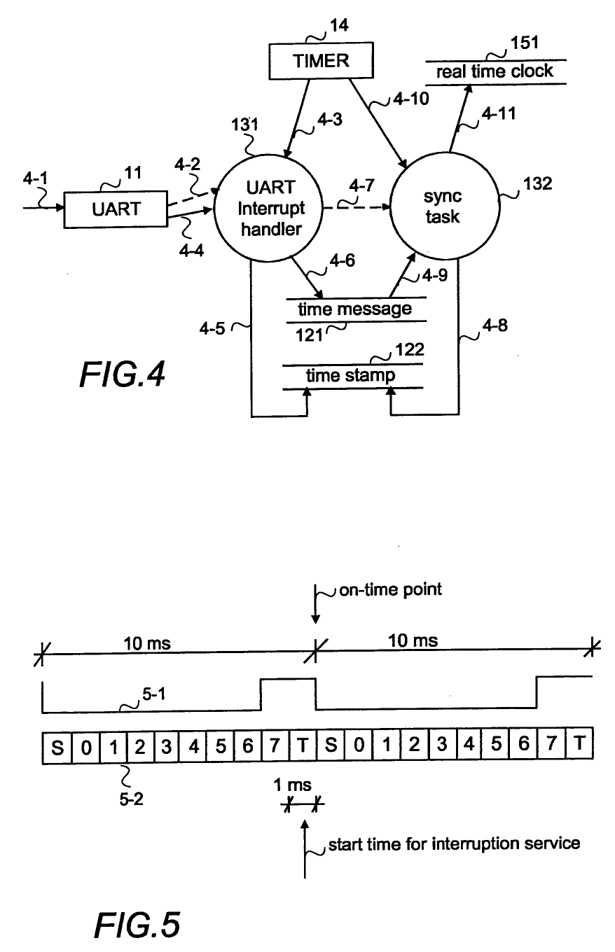

FIGS. 3A and 3B illustrate a schematic diagram of a connection arrangement suitable for an RS485 interface according to embodiments based on Universal Asynchronous Receiver & Transmitter circuits (UARTs) integrated in a microcontroller and adapted for receiving an IRIG-B time signal. The adaptation of a serial communications circuit and the IRIG-B serial time code used for time synchronization, which is one of the main types of serial time codes developed by Inter-Range Instrumentation Group, are described in more detail below.

The connection arrangement comprises two data lines DA and DB, three resistors R1, R2, R3 connected in series to the operating voltage VCC and ground, a bus driver U1, an inverter U3 and a microcontroller U2.

The differential RS485 data bus is a bi-directional half-duplex bus requiring two lines. In the solution according to the invention, it is used for receiving a time signal. The data bus consists of two twisted conductors; the A and B conductors are connected to the corresponding inputs, DA and DB. The resistors are used for setting the input to a specific state, preferably the logical 1 state. For example, the resistance of resistors R1 and R3 is 680 Ω and the resistance of resistor R2 is 120Ω, while the operating voltage is typically 5 V. The received time signal is connected to bus driver U1, which converts the time signal to TTL (Transistor-Transistor-Logic) level. Microcontrollers usually employ TTL levels of 5 V or 3.3 V. Bus driver U1 is connected so that transmission is prevented and reception is always active, ensuring that the time signal can always be received. Bus driver U1 supplies the TTL-level time signal to inverter U3. Inverter U3 is connected to a data input pin on the actual serial communications circuit, such as the PD0/RXD pin, which is pin 10 on an AT90S8515 microcontroller, for example. Inverter U3 inverts the time signal so that the rising edge of the signal containing the time data goes to the serial communications circuit as a falling edge that the serial communications circuit interprets as a start bit.

A diode and/or a zener diode can be used in place of bus driver U1 to achieve TTL level (cutting off negative voltages and excessively high voltages).

The schematic in FIG. 3B differs from FIG. 3A in that the conductors going to the DA and DB connectors are cross-connected, eliminating the need for a separate inverter. The cross-connection inverts the IRIG-B time signal. In all other respects the connection arrangement is similar to FIG. 3A.

A schematic according to FIG. 3A comprising an inverter is suitable for use with an RS232 interface if the voltage divider resistor arrangement is removed and the bus driver is replaced with an RS232 buffer. In other words, it is enough for an RS232 interface to connect the incoming Rx signal line (and signal ground) directly to the bus driver.

In some other embodiment of the invention, the received time signal may be modulated, in which case the device subject to synchronization comprises a demodulator for receiving the time signal.

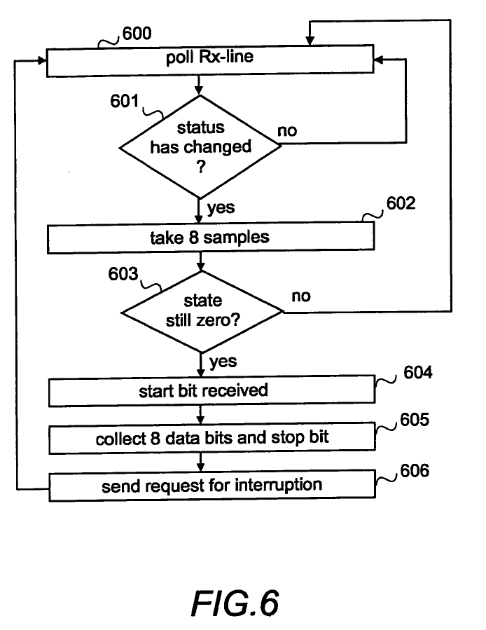

FIG. 4 is a high-level software, data communications and command diagram for a microcontroller according to an embodiment of the invention. The circles in FIG. 4 represent the CPU program routines used for time synchronization, the parallel lines close to each other represent data storage, and the rectangles represent units. The dashed lines represent commands, while the solid lines represent data communications. The program routines for time synchronization, the UART interrupt handler 131 and the sync task 132 can preferably be programmed into the microcontroller on the printed circuit board without any separate programming device. The programming language can use the syntax of Visual Basic, C, C++ or Java, for example. However, the language and means of implementing the program routines and the means of programming the microcontroller or its CPU containing the program routines is insignificant with regard to the invention. Embedded systems, for example, often use a real-time operating system that enables virtually simultaneous execution of different tasks such as the sync task.

In the example of FIG. 4, the time signal 4-1 is received in serial communications circuit (UART) 11. The polarity of the leading edge of the time signal must be identical to the leading edge polarity detected by the serial communications circuit. Therefore the time signal is inverted if necessary before the serial communications circuit receives the time signal. Each time the serial communications circuit receives a new character, it uses the command 4-2 to initiate interrupt handler 131 that reads 44 the received time character from the serial communications circuit, reading the states of the serial communications circuit into memory. The interrupt handler can take 4-3 a time stamp from timer 14 at the start of a specific character, preferably the start of an on-time character, and store 4-5 the time stamp into memory 122. Interrupt handler 131 stores 4-6 the received time message to memory 121 and initiates (4-7) the sync task 132 once the characters required for synchronization have been received. Initiation can be carried out using a command signal provided by the operating system or by setting a bit in memory that the sync task expects to be set. Sync task 132 carries out the actual time synchronization. The sync task retrieves 4-8 time stamp 122. Furthermore, the sync task retrieves 4-9 time message 121 and takes 4-10 a new time stamp from timer 14. The sync task is able to compensate for the time spent on transmission of the time characters using this time stamp and the time stamp taken by the interrupt handler. The sync task also synchronizes 4-11 the real-time clock.

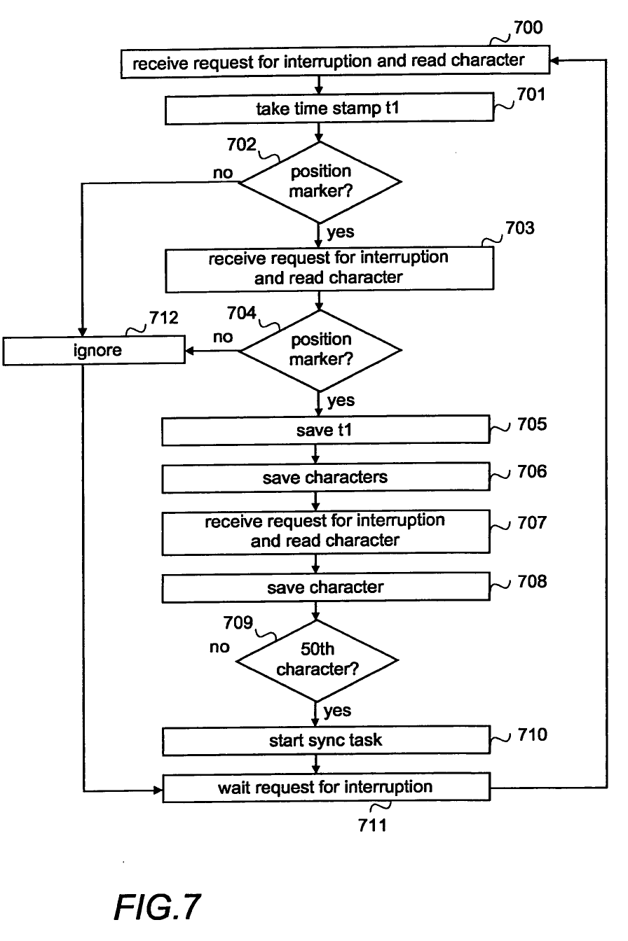

In the following an embodiment of the invention is described in more detail with the help of FIGS. 5, 6, 7 and 8 using an example in which an IRIG-B time signal is received using a connection arrangement according to FIG. 3A or 3B, a microcontroller containing a 8-bit asynchronous serial communications circuit, such as an AT90S8515, that includes the arrangement illustrated in connection with FIG. 4. Furthermore, for the sake of clarity, it is assumed in the figures that the received time signal is error-free.

The duration of an IRIG-B frame is one second, and it can be transmitted either at the DC level in phase-modulated form, or modulated on a 1000 Hz carrier. The frame starts with a reference marker, which comprises two consecutive position markers, first called a frame reference marker and the latter one a reference bit, the reference marker being followed by the actual time calculated from the beginning of the year in BCD (Binary Coded Decimal) notation. The frame comprises 100 pulses with the leading edges starting at 10 ms intervals. Therefore the pulse interval of the frame is 10 ms. As each pulse corresponds to one character—that is, one IRIG-B bit—the data transmission rate of the time signal is 100 bits per second. The duration of a position marker is 8 ms, the duration of a binary zero (“0”) is 2 ms and the duration of a binary one (“1”) is 5 ms. Each element or IRIG-B bit starts with a rising edge followed by a falling edge with an interval of 2, 5 or 8 milliseconds. The actual time is communicated by the first 50 elements (including the reference marker starting the frame)—that is, within 0.5 seconds. The on-time point, which refers to the point in time communicated in the frame, is the leading edge of the second position marker starting the frame. The time is specified using the following fields: seconds, tens of seconds, hours, tens of hours, days, tens of days and hundreds of days. All fields are separated by a binary zero (“0”). Furthermore, every tenth element is a position marker (repeated at intervals of 100 ms). Because the structure of an IRIG-B time frame is well known to a person skilled in the art, it is not described in more detail here.

The UART serial communications circuit uses asynchronous communication in which a character starts with a start bit and ends with a stop bit. The UART detects a start bit by the falling edge of the received signal. In an 8-bit serial communications circuit, there are 8 data bits between these. Thus, the frame length of a serial communications circuit according to the example is 10 bits. The duration of the frame must be substantially identical to the pulse interval in the time signal—that is, 10 ms—so the data transmission rate of the serial communications circuit receiving the demodulated time signal must be set to 1000 bits per second. In other words, the serial communications circuit is configured to receive the time signal so that the data transmission rate of the serial communications circuit is preferably set to the data transmission rate of the time signal, multiplied by the number of bits in each frame of the serial communications circuit. This enables one IRIG-B bit to be read into the UART as one 8-bit character. The UART will re-synchronize itself with the bit sequence at the next falling edge even if the data transmission rate is not exactly 1000. Therefore the data transmission rate setting does not need to be perfectly precise; for example, reception will succeed with an error of 2% (that is, rates from 980 to 1020 bits per second).

FIG. 5 illustrates the two position markers starting the inverted IRIG-B time signal received by the serial communications circuit, each having a duration of 10 ms, and the bit sequence 5-2 obtained by the serial communications circuit by sampling them; in the bit sequence, S refers to a start bit, T refers to a stop bit and the numbers from 0 to 7 refer to the corresponding data bits. Because the signal level will be a logical 0 for the last 2 ms of even the longest IRIG-B pulses, the bits 7 and T have a value of 1 in all inverted IRIG-B characters. This allows the UART to detect errors in the received bit sequence. Each IRIG-B bit can be received as an individual character; in the example illustrated in the figure, the least significant bit (LSB) comes first.

FIG. 5 also illustrates the relationship between the time the interrupt handler is initiated and the on-time point when a serial communications circuit according to the invention is arranged to initiate the interrupt handler at the midpoint of the first stop bit, in this example 0.5 ms before the on-time point.

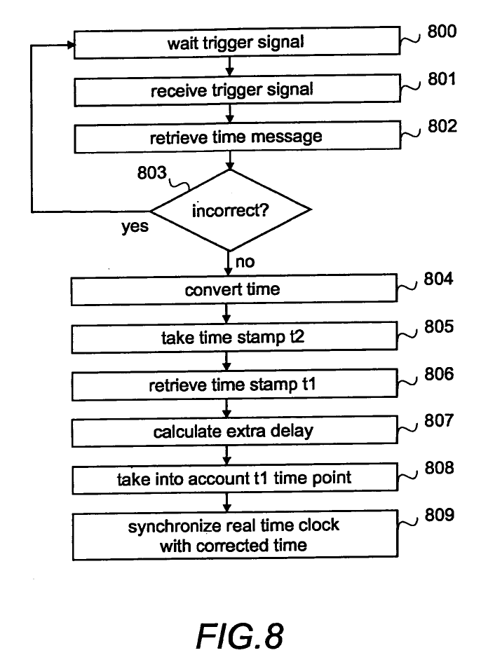

FIG. 6 illustrates more details of the operation of the UART serial communications circuit in the embodiment described above. The serial communications circuit receives the time signal by sampling the input line, usually at a rate 16 times greater than the data transmission rate. Therefore the sampling rate in this example is 16 kHz.

At step 600 the serial communications circuit polls the input line until it detects a state change—that is, a falling edge (step 601). Once the state change is detected (step 601), the serial communications circuit takes eight samples. If the samples indicate that the received data has remained in the logical zero state (step 603), the serial communications circuit interprets at step 604 that it has received a start bit, after which it collects the following eight data bits and the stop bit at step 605 by taking samples at intervals of 16 clock cycles, always at the midpoint of a bit. Three samples are taken at the midpoint of each bit, and the state of the majority is used to resolve whether a logical one or a logical zero is received. At a stop bit, the received data is in a logical one state. Once the data bits of the frame have been collected, the serial communications circuit transmits an interrupt request to the interrupt handler at the midpoint of the stop bit at step 606, and starts the reception of a new character or IRIG-B bit in response to a state change after the stop bit (601). If the state does not change, the serial communications circuit polls (step 600) the input line until it detects a state change.

If the received data has not remained in a logical zero state (step 603) after the state change, the falling edge did not mean a start character, and the serial communications circuit continues to poll the input line (step 600).

In the normal state, the serial communications circuit only receives three different types of characters: the position marker, the IRIG-B bit value zero and the IRIG-B bit value one. Other values indicate reception errors, as does a stop bit value of zero. When the serial communications circuit detects a reception error, it reports a frame error. If a logical one is received for a sufficiently long period, the serial communications circuit switches to an idle state after the stop bit. Correspondingly, if a logical zero is received for a sufficiently long period, the serial communications circuit reports that it has received a break signal. The reference marker is received as a 8-bit byte 10000000 or the hexadecimal value 80H, an IRIG-B zero is received as a 8-bit byte 11111110 or the hexadecimal value FEH, and an IRIG-B one is received as a 8-bit byte 11110000 or the hexadecimal value FOH (most significant bit first).

In some other embodiments, the serial communications circuit can also calculate a parity bit.

FIG. 7 illustrates more details of the operation of the interrupt handler in connection with the serial communications circuit of FIG. 6. The operation starts when an interrupt request is received from the serial communications circuit at step 700 and the character received by the serial communications circuit is read from the circuit. There is 10 ms of time to read the character. At step 701, the interrupt handler takes a time stamp t1 from the on-chip timer in response to the reception of an interrupt request. After this, at step 702, the interrupt handler checks if the read character was a position marker. If this was the case, the character is a potential start bit and the interrupt handler switches to a state in which it waits for another position marker. Subsequently, at step 703, the interrupt handler receives the next interrupt request and reads the next character (that is, the next character received by the serial communications circuit). If this is also a position marker (step 704), the device is receiving a synchronization time, and time stamp t1 is stored at step 705. The stored time stamp is now 0.5 ms before the on-time point. If necessary, the time taken to start the interrupt handler, also known as the latency period, can be taken into account. If the priority of the interrupt handler is high, its latency period is in the order of tens of microseconds (in the example illustrated here, the timing precision of the interrupt request is approximately 62.5 microseconds), so it is insignificant with regard to the typical precision of this method, which is ±0.5 ms or ±500 microseconds. At step 706, the first two position markers read are stored as the first two characters of the time message. The time message's other characters are obtained by repeating step 707, in which the interrupt request is received and the character is read, and step 708, in which the character is stored until the 50th character of the time frame has been received (step 709). When the time, in this example the 50 first characters of the time frame, has been received, the sync task is initiated at step 710, and the interrupt handler waits for an interrupt request at step 711. The next 50 characters of the time signal are ignored, and the start of a new time frame is detected by two consecutive position markers.

If the first character (step 702) or the second character (step 704) was not a position marker, the character or characters read are ignored (step 712) and the interrupt handler proceeds to step 711, waiting for an interrupt request.

In some other embodiment of the invention, the interrupt handler may take the time stamp only at the midpoint of the stop bit of the second (consequent) position marker, in which case time stamp t1 is taken 9.5 ms too late.

If the interrupt handler detects an error, it suspends the reception of time, preferably initialises the memories and waits for a new interrupt request, returning to step 700.

FIG. 8 illustrates the operation of the sync task in connection with the interrupt handler illustrated in FIG. 7 by means of a flow diagram. At step 800 the sync task waits for a trigger signal from the interrupt handler. Once the sync task receives the trigger signal at step 801, it retrieves the time message at step 802; in this example, the time message comprises the first 50 characters of the time frame stored by the interrupt handler. After this the sync task verifies at step 803 whether the time message read contains errors. If this is the case, the task returns to the waiting state at step 800.

If the time message does not contain errors (step 803), the time is converted to the time format required by the system at step 804. After this a second time stamp t2 is taken from the timer at step 805, the first time stamp t1 is retrieved at step 806, and an additional delay caused by the program routines is calculated on the basis of these time stamps at step 807, subtracting 0.5 ms at step 808. The subtraction is carried out because the first time stamp was taken 0.5 ms too early. In an embodiment in which time stamp t1 is taken 9.5 ms too late, 9.5 ms is added to the additional delay caused by the program routines. This allows the point of time of time stamp t1 to be taken into account. Furthermore, the latency period of the interrupt handler could be taken into account, but as stated above, this is generally insignificant and can be ignored. Finally the real-time clock is synchronized using the time thus corrected at step 809.

In a preferred embodiment of the invention, the timer includes a capture function. In this embodiment, the time signal is also branched to the input of the timer's capture function. Depending on the timer settings, the capture function is activated either by the falling or the rising edge, so depending on the settings, the timer receives either an inverted or a non-inverted time signal. The capture function activated by the leading edge stores the time value in the timer's counter in a capture register at the same time as the serial communications circuit starts to receive the start bit. In other words, the capture function receives a precise time stamp at the very beginning of the character, unaffected by the latency of the interrupt handler. Therefore the sync task does not need to account for the point of time when the time stamp was taken, eliminating step 808 in the example of FIG. 8. Depending on the embodiment, the time stamp is read either by the interrupt handler or the sync task.

An embodiment in which the interrupt handler reads the time stamp from the capture register differs from the embodiment illustrated in FIG. 4 so that the timer capture function also receives the time signal 4-1; the precise time stamp of the signal's leading edge is stored in the capture register and read from there by the interrupt handler. In this embodiment, the interrupt handler has 0.5 milliseconds to read the time stamp before the leading edge of the next character (position marker or IRIG-B bit) triggers the capture of a new time stamp. (The serial communications circuit initiates the interrupt handler at the midpoint of the stop bit or 9.5 ms after starting to receive the character.) In this embodiment, step 701 is eliminated from the example of FIG. 7, and the time stamp is read from the capture register at step 705.

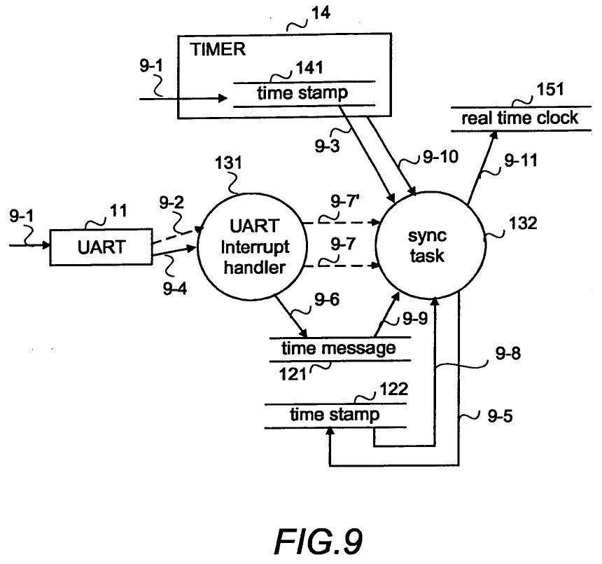

FIG. 9 illustrates an arrangement according to an embodiment in which the sync task reads a captured time stamp as a high-level software, data communications and command diagram. The example arrangement contains the same elements as FIG. 4, with the exception that timer 14 includes a capture function that reads 9-1 the point of time of the leading edge of the time signal into the register 141 as a time stamp. The time signal 9-1 is also carried to the serial communications circuit. The polarity of both time signals is adapted as described above so that the serial communications circuit and the capture function detect the leading edge. Each time the serial communications circuit receives a new character, it uses the command 9-2 to initiate interrupt handler 131 that reads 9-4 the received time character from the serial communications circuit, reading the states of the serial communications circuit into memory. If the character starts a time frame, the interrupt handler initiates 9-7′ the sync task as described in connection with FIG. 4, for example. The sync task retrieves 9-3 the time stamp from capture register 141 and stores 9-5 the time stamp in memory 122. Interrupt handler 131 stores 9-6 the received time message in memory 121 and initiates 9-7 sync task 132, as described in connection with FIG. 4, for example, once the characters required for synchronization have been received. Sync task 132 carries out the actual time synchronization. The sync task retrieves 9-8 time stamp 122. Furthermore, the sync task retrieves 9-9 the time message 121 and takes 9-10 a new time stamp from timer 14. The sync task is able to compensate for the time spent on transmission of the time characters using this time stamp and the time stamp retrieved earlier. The sync task also synchronizes 9-11 the real-time clock. The stimulus 9-7′ with which the sync task is initiated to read the time stamp can be a different command than the stimulus 9-7 with which the sync task is initiated to synchronize the clock.

In other words, in the example of FIG. 9 in which the sync task reads the time stamp, the interrupt handler initiates the sync task once it has received the first reference character. This means that at step 701 in the example of FIG. 7, a time stamp is not taken but the sync task is initiated. In this embodiment, the interrupt handler does not store the time stamp but step 705 is eliminated. When the sync task is initiated for the first time or after synchronizing the real-time clock in this embodiment, the sync task will wait for a minimum of 0.5 ms, preferably 2 to 3 ms, in order for the time stamp for the next IRIG-B bit to be stored in the capture register, before reading the time from the capture register. This ensures that the time in the capture register equals the on-time point. On the other hand, the sync task has a maximum of 10 milliseconds, with a preferred alternative 7 to 8 ms, to read the time stamp into memory before the leading edge of the next IRIG-B bit causes a new time value to be captured in the capture register. After reading the time stamp, the sync task waits for a trigger signal from the interrupt handler and synchronizes the clock as described above.

The steps illustrated in FIGS. 2, 4, 6, 7 and 8 are not in absolute chronological order. They can be carried out in deviation from the specified order or simultaneously. Some of the steps can also be eliminated or replaced by configuration/settings of the device. Such steps include, for example, taking time stamp t1 or converting the time to the time format required by the system if the time is already in that format. Other functions can be carried out between the described steps or simultaneously with them.

Even though the invention has been described above in connection with an asynchronous serial communications circuit, it is obvious to a person skilled in the art that the invention can also be applied in connection with a synchronous circuit, such as a USART (Universal Synchronous Asynchronous Receiver & Transmitter), when synchronizing a device to a time obtained from a satellite.

The embodiments described above are examples, and the characteristics described for an individual embodiment are not necessarily characteristics of the same embodiment. Correspondingly, an individual characteristic can be shared by several embodiments. The individual characteristics of different embodiments can be combined to create other embodiments according to the invention.

An arrangement, microcontroller or device implementing the functionality according to the present invention comprises means for synchronizing a real-time clock using time received through a serial communications circuit. More precisely it comprises means for implementing at least one of the embodiments described above. Current microcontrollers and other devices equipped with a serial communications circuit and a central processing unit also comprise memory that can be utilized for functions according to the invention. All of the changes and configurations required for implementing the invention can be carried out as added or updated software routines that can be stored on any media that can be read using the device, or from which the routines can be loaded to the device.

It is obvious to a person skilled in the art that the progress of technology will allow the fundamental idea of the invention to be implemented in many different ways. Thus the invention and its embodiments are not limited to the examples described above, but may vary within the scope of the claims.

1. A method for synchronizing a real-time clock, the method comprising
synchronizing the real-time clock according to a received time signal,
comprising:
adapting the data transmission rate of a serial communications circuit so that one character of the time signal can be read into the serial communications circuit as one character; and
receiving the time signal used for synchronization through the serial communications circuit.

2. A method according to claim 1, wherein the method further comprises
receiving a time signal with a rising leading edge of the pulses; and
inverting the time signal before it is received in the serial communications circuit.

3. A method according to claim 1, wherein the method further comprises
taking a first time stamp in response to the start of a time frame;
storing the received time signal as a time message from the start of the time frame until the pulses of the time frame representing the actual time have been received;
converting the time in the time message;
taking a second time stamp;
making a correction to the converted time on the basis of the time stamps; and
synchronizing the real-time clock using the corrected time.

4. A serial communications circuit, wherein it is configured to receive a time signal so that the data transmission rate of the serial communications circuit is set to a rate that allows one pulse interval in the time signal to be read into one frame in the serial communications circuit.

5. A serial communications circuit according to claim 4, wherein its data transmission rate is substantially equal to the data transmission rate of the time signal multiplied by the number of bits in each frame of the serial communications circuit.

6. A serial communications circuit according to claim 4 wherein it is configured to initiate a routine for reading a received time pulse in response to the completion of reading one pulse interval.

7. A serial communications circuit according to claim 4, wherein it is an asynchronous serial communications circuit.

8. A microcontroller comprising a serial communications circuit, memory, a central processing unit, a real-time clock and a first routine for synchronizing the real-time clock, wherein
the serial communications circuit is configured to receive the time signal at a rate that allows one pulse interval in the time signal to be read into one frame in the serial communications circuit; and in that
the microcontroller comprises a second routine responsive to the serial communications circuit, to read the time signal received by the serial communications circuit into a time message used for time synchronization, and initiates the first routine in response to the completion of the time message.

9. A connection arrangement comprising a serial communications circuit, memory, a central processing unit and a first routine for time synchronization, wherein
the connection arrangement comprises means (U1, R1, R2, R3, DA, DB) for supplying a time signal to the serial communications circuit and a second routine that responds to the serial communications circuit and reads the time signal received by the serial communications circuit into a time message used for time synchronization, and initiates the first routine in response to the completion of the time message; and
the data transmission rate of the serial communications circuit is set to a rate that allows one pulse interval in the time signal to be read into one frame in the serial communications circuit.

10. A connection arrangement according to claim 9, wherein it comprises an inverter (U3) for inverting the time signal.

11. A connection arrangement according to claim 9, wherein it comprises a cross-connection for inverting the time signal.

12. A device comprising a real-time clock and means for receiving a time signal, wherein the device comprises a connection arrangement according to claim 9, and is adapted to use it for time synchronization of the real-time clock.
